(19) United States
(12) Patent Application Publication
(10) Pub. No.: US 2026/0103065 A1
(43) Pub. Date: Apr. 16, 2026

(54) VEHICLE UNDERFLOOR STRUCTURE

(71) Applicant: Toyota Jidosha Kabushiki Kaisha, Toyota-shi (JP)

(72) Inventor: Nobuyasu Nishiki, Toyokawa-shi (JP)

(73) Assignee: Toyota Jidosha Kabushiki Kaisha, Toyota-shi (JP)

(21) Appl. No.: 19/245,899

(22) Filed: Jun. 23, 2025

(30) Foreign Application Priority Data
Oct. 16, 2024 (JP) 2024-181287

(51) Int. Cl. B60K 1/04; B60R 16/023; B62D 25/20

(52) U.S. Cl. CPC B60K 1/04; B60R 16/0239; B62D 25/20; B60K 2001/0438

(57) ABSTRACT

A vehicle underfloor structure includes a first support pillar including a first end disposed at a fixing portion and a second end standing toward an upper case, a first cushioning member disposed on a surface of the first support pillar at the second end and compressed by the first support pillar and a device base, a second support pillar including a first end disposed at a position where the second support pillar faces the first cushioning member across the device base, and a second end standing toward the upper case and abutting against the upper case, and a second cushioning member disposed at a position where the second cushioning member faces the second support pillar across the upper case, and compressed by the upper case and a floor panel of a vehicle.

### CROSS-REFERENCE TO RELATED APPLICATION

This application claims priority to Japanese Patent Application No. 2024-181287 filed on Oct. 16, 2024. The disclosure of the above-identified application, including the specification, drawings, and claims, is incorporated by reference herein in its entirety.

### BACKGROUND

### 1. Technical Field

The present disclosure relates to a vehicle underfloor structure.

### 2. Description of Related Art

Japanese Unexamined Patent Application Publication No. 2023-046826 (JP 2023-046826 A) discloses a battery in which battery cells can be protected from a load input to a case in an up-down direction.

### SUMMARY

The case that houses battery cells as in JP 2023-046826 A may house electronic devices such as an electronic control unit (ECU) and a satellite battery module (SBM) in addition to the battery cells. In such a case, it is necessary to protect the electronic devices by suppressing vibration applied to the electronic devices. However, JP 2023-046826 A does not provide any disclosure about the protection of the electronic devices housed in the case. Therefore, there is room for improvement.

In view of the above, an object of the present disclosure is to provide a vehicle underfloor structure that can provide measures against vibration on a predetermined electronic device housed in an internal space formed between an upper case and a lower case.

A vehicle underfloor structure according to claim 1 includes: a lower case in which a battery module including a combination of a plurality of battery cells is disposed; a junction box fixed to a vehicle upper side of the lower case at a fixing portion provided to face the lower case; a device base on which a predetermined electronic device is disposed and that is attached to the lower case at a plurality of attachment points to cover the junction box; an upper case that covers the lower case and defines an internal space between the upper case and the lower case to house the battery module, the junction box, and the device base; a first support pillar including a first end disposed at the fixing portion and a second end standing toward the upper case; a first cushioning member disposed on a surface of the first support pillar at the second end and compressed by the first support pillar and the device base; a second support pillar including a first end disposed at a position where the second support pillar faces the first cushioning member across the device base, and a second end standing toward the upper case and abutting against the upper case; and a second cushioning member disposed at a position where the second cushioning member faces the second support pillar across the upper case, and compressed by the upper case and a floor panel of a vehicle.

In the vehicle underfloor structure according to claim 1, the compressed first cushioning member suppresses downward movement of the device base in a vehicle up-down direction when vibration occurs downward in the vehicle up-down direction. In the vehicle underfloor structure, the compressed second cushioning member suppresses upward movement of the device base in the vehicle up-down direction when vibration occurs upward in the vehicle up-down direction. Therefore, the vehicle underfloor structure can provide measures against vibration on the predetermined electronic device housed in the internal space formed between the upper case and the lower case.

In the vehicle underfloor structure according to claim 2, in claim 1, the fixing portion is a recess that is recessed toward the lower case, the junction box is fixed to the lower case by fixing a collar in a hole at a bottom of the recess and the lower case with a fastener, and the first end of the first support pillar is provided in the recess and abuts against the fastener.

In the vehicle underfloor structure according to claim 2, the junction box is fixed to the lower case by fixing the collar in the hole at the bottom of the recess and the lower case with the fastener. The first end of the first support pillar is provided in the recess and abuts against the fastener. With the vehicle underfloor structure, when vibration occurs downward in the vehicle up-down direction, the load can be transmitted to the fastener, the collar, and the lower case, thereby suppressing the input of the load to the junction box.

In the vehicle underfloor structure according to claim 3, in claim 2, when the junction box and the device base are attached to the lower case, the attachment points are located outward of the junction box in a vehicle width direction, the junction box is fixed to the lower case at a plurality of recesses that is recessed toward the lower case, and the recess is, among the plurality of recesses, a recess closest to a midpoint between the attachment points adjacent to each other in the vehicle width direction.

In the vehicle underfloor structure according to claim 3, when the junction box and the device base are attached to the lower case, the attachment points are located outward of the junction box in a vehicle width direction. The recess to which the first support pillar is provided is, among the plurality of recesses, the recess closest to the midpoint between the attachment points adjacent to each other in the vehicle width direction. With the vehicle underfloor structure, the central portion of the device base in the vehicle width direction that is not fixed to the lower case is held by the first support pillar, the first cushioning member, the second support pillar, and the second cushioning member, thereby improving the vibration strength of the device base.

In the vehicle underfloor structure according to claim 4, in claim 2, the junction box is fixed to the lower case at a plurality of recesses that is recessed toward the lower case, and the recess is all of the recesses.

In the vehicle underfloor structure according to claim 4, the recess to which the first support pillar is provided is all of the recesses. With the vehicle underfloor structure, the vibration strength of the device base can be improved compared to the configuration in which the first support pillar is provided to only part of the recesses.

As described above, the vehicle underfloor structure according to the present disclosure can provide measures against vibration on the predetermined electronic device housed in the internal space formed between the upper case and the lower case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle including a battery;

FIG. 2 is a plan view schematically showing an underfloor structure of the vehicle that is viewed from the top; and

FIG. 3 is a sectional view taken along line A-A in FIG. 2.

### DETAILED DESCRIPTION OF EMBODIMENTS

Embodiments of the present disclosure will be described below with reference to the drawings. Arrow U in the drawings indicates an upper side in a vehicle up-down direction. Arrow D indicates a lower side in the vehicle up-down direction. Arrow Fr indicates a front side in a vehicle front-rear direction. Arrow Re indicates a rear side in the vehicle front-rear direction. Arrow L indicates a left side in a vehicle width direction. Arrow R indicates a right side in the vehicle width direction. The upper side in the vehicle up-down direction is an example of a “vehicle upper side” in the present disclosure.

### First Embodiment

First, a first embodiment of the present disclosure will be described.

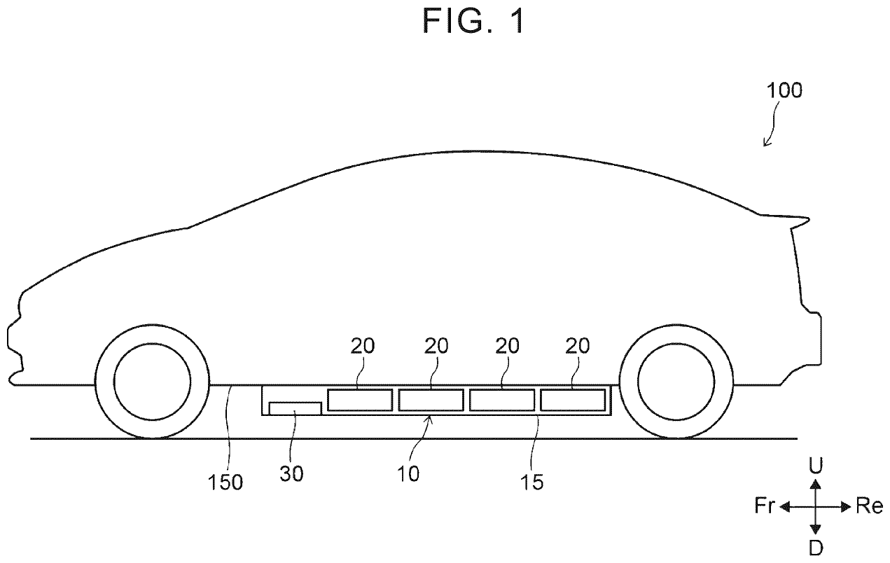

FIG. 1 is a schematic diagram showing a vehicle 100 including a battery 10. The battery 10 is mounted on the vehicle 100 shown in FIG. 1. The battery 10 is mounted on the vehicle 100 including an electric motor as a drive source for traveling, and outputs direct current power that can be used to drive the electric motor. Examples of the vehicle 100 include a hybrid electric vehicle (HEV), a plug-in hybrid electric vehicle (PHEV), and a battery electric vehicle (BEV).

The battery 10 is disposed below a floor panel 150 of the vehicle 100 in the vehicle up-down direction. The battery 10 includes a housing case 15, a plurality of battery modules 20, a junction box 30, etc.

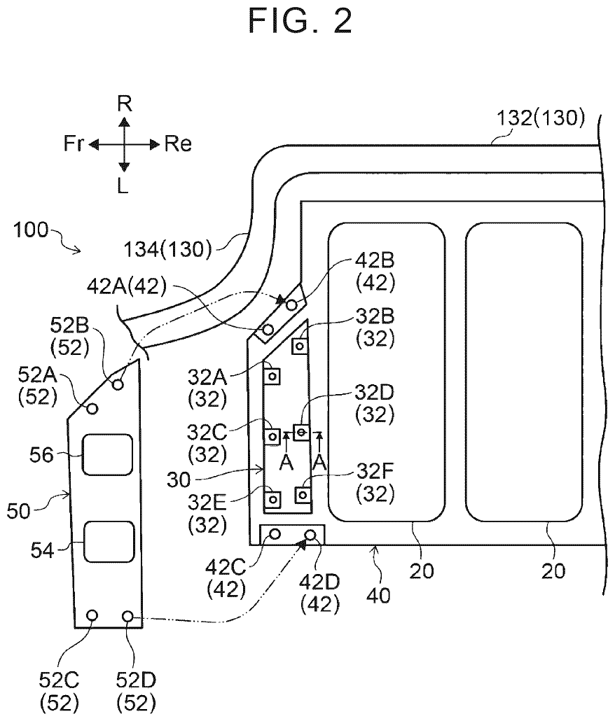

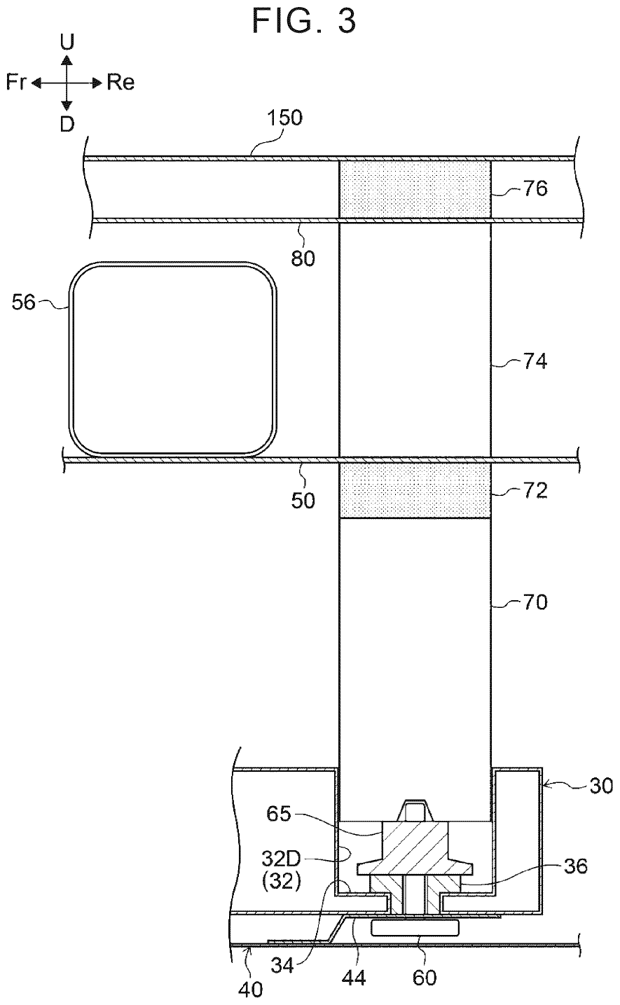

The housing case 15 includes an upper case 80 (see FIG. 3) and a lower case 40 (see FIGS. 2 and 3). The housing case 15 houses the battery modules 20, the junction box 30, etc.

The battery modules 20 are disposed side by side in the vehicle front-rear direction. Each of the battery modules 20 includes a plurality of battery cells (not shown). The battery cells are disposed side by side in the vehicle width direction.

The battery cell is a secondary battery such as a nickel metal hydride battery or a lithium ion battery. The battery cell may be a cell using a liquid electrolyte or a cell using a solid electrolyte. The battery cell may be a unit capacitor that can be charged and discharged. The battery cell has, for example, a rectangular shape.

When disposed inside the housing case 15, the junction box 30 is located forward of the battery modules 20 in the vehicle front-rear direction. The junction box 30 is electrically connected to the battery modules 20. The junction box 30 is a device (electrical distribution box) that relays electrical connections between devices.

FIG. 2 is a plan view schematically showing a lower side of the floor panel 150 in the vehicle up-down direction, that is, an underfloor structure of the vehicle 100 that is viewed from the top. FIG. 2 shows the underfloor structure at the front portion in the vehicle front-rear direction in the lower case 40 in which the junction box 30 is disposed.

As shown in FIG. 2, the junction box 30 has a plurality of recesses 32 as fixing portions provided to face the lower case 40, that is, downward in the vehicle up-down direction, and recessed downward in the vehicle up-down direction. The junction box 30 is fixed to the upper side of the lower case 40 in the vehicle up-down direction at the recesses 32. The recesses 32 include a recess 32A and a recess 32B provided at the right end of the junction box 30 in the vehicle width direction, a recess 32C and a recess 32D provided at the center of the junction box 30 in the vehicle width direction, and a recess 32E and a recess 32F provided at the left end of the junction box 30 in the vehicle width direction. As described above, the battery modules 20 are disposed rearward of the junction box 30 in the vehicle front-rear direction when the junction box 30 is fixed to the lower case 40.

A plurality of fastening points 42 for attaching a device base 50 on which an ECU 54 and an SBM 56 are disposed is provided outward of the junction box 30 in the vehicle width direction in the lower case 40 shown in FIG. 2. The fastening points 42 include a fastening point 42A and a fastening point 42B provided rightward of the junction box 30 in the vehicle width direction, and a fastening point 42C and a fastening point 42D provided leftward of the junction box 30 in the vehicle width direction.

FIG. 2 shows the device base 50 to be attached to the lower case 40. On the device base 50, the SBM 56 is disposed on the right side in the vehicle width direction, and the ECU 54 is disposed leftward of the SBM 56 in the vehicle width direction. The ECU 54 and the SBM 56 are examples of a “predetermined electronic device” in the present disclosure.

The device base 50 has, as a plurality of attachment points 52 mating with the fastening points 42, an attachment point 52A and an attachment point 52B provided rightward of the SBM 56 in the vehicle width direction, and an attachment point 52C and an attachment point 52D provided leftward of the ECU 54 in the vehicle width direction. Using bolts and nuts (not shown), the attachment point 52A is fastened to the fastening point 42A, the attachment point 52B is fastened to the fastening point 42B, the attachment point 52C is fastened to the fastening point 42C, and the attachment point 52D is fastened to the fastening point 42D. When the junction box 30 and the device base 50 are attached to the lower case 40, the device base 50 is disposed above the junction box 30 in the vehicle up-down direction. That is, the device base 50 is attached to the lower case 40 to cover the junction box 30 at the attachment points 52. When the junction box 30 and the device base 50 are attached to the lower case 40, the attachment points 52 of the device base 50 are located outward of the junction box 30 in the vehicle width direction.

In the underfloor structure of the vehicle 100 shown in FIG. 2, an exhaust pipe 130 is provided rightward of the lower case 40 in the vehicle width direction. The exhaust pipe 130 includes a straight portion 132 that extends along the vehicle front-rear direction, and a curved portion 134 that curves leftward in the vehicle width direction from the front end of the straight portion 132 and extends forward in the vehicle front-rear direction. The front end portion of the lower case 40 has a scooped shape at the right end in the vehicle width direction to extend aside from the exhaust pipe 130. Therefore, a space sufficient for disposing the battery module 20 cannot be secured at the front end portion. Instead, the junction box 30 and the device base 50 that require a space narrower than that for the battery module 20 are disposed.

FIG. 3 is a sectional view taken along line A-A in FIG. 2. Specifically, FIG. 3 shows a vertical cross section taken vertically along line A-A in FIG. 2 at the center of the recess 32D in the vehicle width direction when the junction box 30 and the device base 50 are attached to the lower case 40. The lower case 40 is made of a steel plate etc.

As shown in FIG. 3, a metal collar 36 is inserted into a hole provided at a bottom portion 34 that is the bottom of the groove of the recess 32D. The collar 36 is in contact with a bracket 44 provided on the lower case 40. The recess 32D is fixed to the lower case 40 by fastening a weld bolt 60 inserted through the bracket 44 and the collar 36 with a nut 65. In this manner, the junction box 30 is fixed to the lower case 40 by fixing the collar 36 inserted into the hole of each recess 32 and the bracket 44 with the weld bolt 60 and the nut 65. The weld bolt 60 and the nut 65 are examples of a “fastener”in the present disclosure.

In FIG. 3, the lower portion of a first support pillar 70 in the vehicle up-down direction is inserted into the recess 32D, and the lower surface of the first support pillar 70 abuts against the nut 65. The first support pillar 70 is a columnar resin member. When inserted into the recess 32D, the first support pillar 70 stands upright in the vehicle up-down direction. A first cushioning member 72 that is a columnar member having the same diameter as the first support pillar 70 is disposed on the upper surface of the first support pillar 70. The first cushioning member 72 is, for example, a cushioning member made of urethane foam. The first cushioning member 72 is compressed by the first support pillar 70 and the device base 50 up to a dimension that provides a pressure load equal to or greater than a predetermined vibration input transmitted to the battery 10.

A second support pillar 74 having a lower portion in the vehicle up-down direction that is attached to the device base 50 by claw engagement etc. is disposed at a position where the second support pillar 74 faces the first cushioning member 72 across the device base 50. The second support pillar 74 is a columnar member made of resin and having the same diameter as the first support pillar 70. When disposed on the device base 50, the second support pillar 74 stands upright in the vehicle up-down direction, and its upper surface abuts against the upper case 80.

The upper case 80 covers the lower case 40 and defines an internal space between the upper case 80 and the lower case 40 to house the battery modules 20, the junction box 30, and the device base 50. The upper case 80 is made of a steel plate etc.

A second cushioning member 76 that is a columnar member having the same diameter as the first support pillar 70 is disposed at a position where the second cushioning member 76 faces the second support pillar 74 across the upper case 80. The second cushioning member 76 is, for example, a cushioning member made of urethane foam. The second cushioning member 76 is compressed by the upper case 80 and the floor panel 150 at the same compression rate as that of the first cushioning member 72.

With the above configuration, in the underfloor structure of the vehicle 100, the compressed first cushioning member 72 suppresses downward movement of the device base 50 in the vehicle up-down direction when vibration occurs downward in the vehicle up-down direction. When vibration occurs downward in the vehicle up-down direction, the downward movement of the device base 50 in the vehicle up-down direction can be stopped by the first support pillar 70 and the first cushioning member 72, thereby suppressing contact between the junction box 30 and the device base 50. Since the downward movement of the device base 50 in the vehicle up-down direction can be stopped, the clearance between the junction box 30 and the device base 50 in the vehicle up-down direction can be reduced, which contributes to reducing the height of the battery 10.

In the underfloor structure of the vehicle 100, the junction box 30 is fixed to the lower case 40 by fixing the collar 36 inserted into the hole of each recess 32 and the bracket 44 with the weld bolt 60 and the nut 65. The lower portion of the first support pillar 70 in the vehicle up-down direction is inserted into the recess 32D and abuts against the nut 65 (see FIG. 3). With the underfloor structure of the vehicle 100, when vibration occurs downward in the vehicle up-down direction, the load can be transmitted to the nut 65, the collar 36, and the lower case 40 while reducing the amplitude, thereby suppressing the input of the load to the junction box 30. Therefore, damage to the junction box 30 is suppressed when vibration occurs downward in the vehicle up-down direction.

In the underfloor structure of the vehicle 100, the compressed second cushioning member 76 suppresses upward movement of the device base 50 in the vehicle up-down direction when vibration occurs upward in the vehicle up-down direction. Specifically, when vibration occurs upward in the vehicle up-down direction, the load can be transmitted to the second support pillar 74, the upper case 80, and the floor panel 150 while reducing the amplitude, thereby suppressing contact between the upper case 80 and the ECU 54 or the SBM 56. Therefore, damage to the ECU 54 and the SBM 56 is suppressed when vibration occurs upward in the vehicle up-down direction.

As described above, the underfloor structure of the vehicle 100 can provide measures against vibration on the ECU 54 and the SBM 56 housed in the internal space formed between the upper case 80 and the lower case 40.

In the underfloor structure of the vehicle 100, the recesses 32 into which the first support pillars 70 are inserted are, among the plurality of recesses 32, the recess 32C closest to the midpoint between the attachment point 52A and the attachment point 52C adjacent to each other in the vehicle width direction, and the recess 32D closest to the midpoint between the attachment point 52B and the attachment point 52D. With the underfloor structure of the vehicle 100, the central portion of the device base 50 in the vehicle width direction that is not fixed to the lower case 40 is held by the first support pillar 70, the first cushioning member 72, the second support pillar 74, and the second cushioning member 76, thereby improving the vibration strength of the device base 50.

### Second Embodiment

Next, a second embodiment of the present disclosure will be described while omitting or simplifying parts that overlap those in the above embodiment.

In the underfloor structure of the vehicle 100 according to the second embodiment, the recesses 32 into which the first support pillars 70 are inserted are all of the recesses 32, specifically, the recesses 32A to 32F. With the underfloor structure of the vehicle 100, the vibration strength of the device base 50 can be improved compared to the configuration in which the first support pillars 70 are inserted into only part of the recesses 32.

What is claimed is:

1. A vehicle underfloor structure comprising:
a lower case in which a battery module including a combination of a plurality of battery cells is disposed;
a junction box fixed to a vehicle upper side of the lower case at a fixing portion provided to face the lower case;
a device base on which a predetermined electronic device is disposed and that is attached to the lower case at a plurality of attachment points to cover the junction box;
an upper case that covers the lower case and defines an internal space between the upper case and the lower case to house the battery module, the junction box, and the device base;
a first support pillar including a first end disposed at the fixing portion and a second end standing toward the upper case;
a first cushioning member disposed on a surface of the first support pillar at the second end and compressed by the first support pillar and the device base;
a second support pillar including a first end disposed at a position where the second support pillar faces the first cushioning member across the device base, and a second end standing toward the upper case and abutting against the upper case; and
a second cushioning member disposed at a position where the second cushioning member faces the second support pillar across the upper case, and compressed by the upper case and a floor panel of a vehicle.

2. The vehicle underfloor structure according to claim 1, wherein:
the fixing portion is a recess that is recessed toward the lower case;
the junction box is fixed to the lower case by fixing a collar in a hole at a bottom of the recess and the lower case with a fastener; and
the first end of the first support pillar is provided in the recess and abuts against the fastener.

3. The vehicle underfloor structure according to claim 2, wherein:
when the junction box and the device base are attached to the lower case, the attachment points are located outward of the junction box in a vehicle width direction;
the junction box is fixed to the lower case at a plurality of recesses that is recessed toward the lower case; and
the recess is, among the plurality of recesses, a recess closest to a midpoint between the attachment points adjacent to each other in the vehicle width direction.

4. The vehicle underfloor structure according to claim 2, wherein:
the junction box is fixed to the lower case at a plurality of recesses that is recessed toward the lower case; and
the recess is all of the recesses.
